(19) United States
(12) Patent Application Publication
(10) Pub. No.: US 2009/0068562 A1
(43) Pub. Date: Mar. 12, 2009

(54) Rechargeable lithium battery

(76) Inventors: Kyoung-Han Yew, Suwon-si (KR); Sung-Soo Kim, Suwon-si (KR); Su-Yeong Park, Suwon-si (KR); Nam-Soon Choi, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/230,945

(22) Filed: Sep. 8, 2008

(30) Foreign Application Priority Data
Sep. 7, 2007 (KR) 10-2007-0091028

(51) Int. Cl. H01M 6/16

(52) U.S. Cl. 429/231.5; 429/324

(57) ABSTRACT

A rechargeable lithium battery includes a positive electrode including a positive active material that can reversely intercalate/deintercalate lithium ions, a negative electrode including a negative active material that can reversely intercalate/deintercalate lithium ions, and a non-aqueous electrolyte including includes a non-aqueous organic solvent, a lithium salt, and at least one additive including a dinitrile-based compound. The negative active material includes a compound represented by LiₓM_{y}V_{z}O_{2+d} wherein 0.1≦x≦2.5, 0≦y≦0.5, 0.5≦z≦1.5, 0≦d≦0.5, and M is a metal selected from the group consisting of Al, Cr, Mo, Ti, W, Zr, and combinations thereof.

### CROSS-REFERENCE TO RELATED APPLICATION AND CLAIM OF PRIORITY

This application claims priority to and the benefit of Korean Patent Application No. 10-2007-0091028 filed in the Korean Intellectual Property Office on Sep. 7, 2007, the entire content of which is incorporated herein by reference.

### BACKGROUND OF THE INVENTION

(a) Field of the Invention

The present invention relates to a rechargeable lithium battery, and more particularly to a rechargeable lithium battery, more particularly to a rechargeable non-aqueous lithium battery.

(b) Description of the Related Art

In recent times, due to reductions in the size and weight of portable electronic equipment in accordance with developments of the electronic industries, such portable electronic equipment has become increasingly used. A battery having a high energy density for a power source of such portable electronic equipment is needed and thus research into a rechargeable lithium battery has been actively conducted.

For a positive active material of a rechargeable lithium battery, lithium-transition element oxide has been used, and for a negative active material, crystalline or amorphous carbon-based material or carbon composite has been used. The positive and negative active materials are coated on a current collector at appropriate thickness and length or the positive and negative active materials are made in the form of a film to fabricate positive and negative electrodes. The positive and negative electrodes are then wound or stacked while insulating separator is being interposed therebetween to fabricate an electrode assembly. The electrode assembly is put into a can or a case, and an electrolyte solution is injected to fabricate a prismatic rechargeable battery.

For the carbon, artificial or natural graphite, hard carbon, and so on have been used for a negative active material. Because the graphite has a low discharge potential of −0.2V, compared to lithium, a battery using graphite as a negative active material has a high average discharge potential of 3.6V and excellent energy density. Furthermore, graphite is most comprehensively used among the aforementioned carbon-based materials since graphite guarantees better cycle life for a battery due to its outstanding reversibility. However, a graphite active material has a low density (theoretical density: 2.2 g/cc) and consequently a low capacity in terms of energy density per unit volume when using the graphite as a negative active material. Further, it involves some dangers such as explosion or combustion when a battery is misused or overcharged and the like, because graphite is likely to react with an organic electrolyte at a high discharge voltage.

In order to solve these problems, a great deal of research on an oxide negative electrode has recently been performed. For example, amorphous tin oxide developed by Japan Fuji Film Co., Ltd. has a high capacity per weight (800 mAh/g). However, this oxide has resulted in some critical defects such as a high initial irreversible capacity of about 50%. Furthermore, its discharge potential is more than 0.5V, and it shows a smooth voltage profile, which is unique in the amorphous phase. Consequently, it was hard to establish a tin oxide to be applicable to a battery. Furthermore, part of the tin oxide has tended to be reduced into tin during the charge or discharge reaction, which is a disadvantage for use in a battery.

Referring to another oxide negative electrode, a negative active material of LiₐMg_{b}VO_{c} (0.05≦a≦3, 0.12≦b≦2, 2≦2c-a-2b≦5) is disclosed in Japanese Patent Publication No. 2002-216753. However, such an oxide negative electrode does not show sufficient battery performance and therefore there has been a great deal of further research into oxide negative materials.

On the other hand, an electrolyte solution for a rechargeable lithium battery includes a lithium salt and an organic solvent. The organic solvent includes a 2 to 5 component-based solvent including cyclic carbonate such as ethylene carbonate, propylene carbonate, and the like and linear carbonate such as dimethyl carbonate, ethylmethyl carbonate, diethyl carbonate, and the like. However, the solvents have a problem of severe swelling at a high temperature.

In order to solve these problems, research on adding various additives to an electrolyte has been variously made. However, when these additives are added, the prepared electrolyte have unexpected defects as well as desired effects. In addition, it may have a problem of a voltage-drop due to unfiltered metal impurities during the battery manufacturing process.

### SUMMARY OF THE INVENTION

One embodiment of the present invention provides a rechargeable lithium battery having increased cell initial formation efficiency, an improved cycle-life, and a voltage drop inhibition characteristic while being allowed to stand at high temperature.

According to an embodiment of the present invention, provided is a rechargeable lithium battery that includes a positive electrode including a positive active material that can reversely intercalate/deintercalate lithium ions; a negative electrode including a compound represented by the following Formula 1; and an electrolyte:

LiₓM_{y}V_{z}O_{2+d} [Chemical Formula 1]

wherein 0.1≦x≦2.5, 0≦y≦0.5, 0.5≦z≦1.5, 0≦d≦0.5, and M is a metal selected from the group consisting of Al, Cr, Mo, Ti, W, Zr, and combinations thereof. The non-aqueous electrolyte includes a non-aqueous organic solvent, a lithium salt, and at least one additive compound represented by the following Formulae 2 to 6:

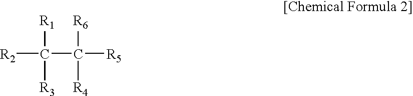

wherein R₁ to R₆ are the same or different, and are selected from the group consisting of hydrogen, a halogen, a substituted or unsubstituted alkyl, a substituted or unsubstituted aryl, and AₓR_{y}, where A is N, O, P or S, R is selected from the group consisting of CN, a substituted or unsubstituted alkyl, and carboxyl, x is 0 or 1, and y is determined according to the valance of A, with the proviso that at least two of R₁ to R₆ are CN.

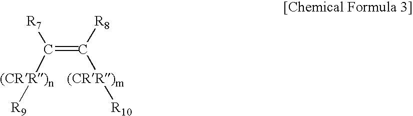

wherein R₇ to R₁₀ are the same or different, and are selected from the group consisting of hydrogen, a halogen, a substituted or unsubstituted alkyl, a substituted or unsubstituted aryl, and AₓR_{y}, where A is N, O, P or S, R is selected from the group consisting of CN, a substituted or unsubstituted alkyl, and carboxyl, x is 0 or 1, and y is determined according to the valance of A, R′ and R″ are independently hydrogen or a lower alkyl, and n and m are an integer ranging from 0 to 10, with the proviso that at least two of R₇ to R₁₀ are CN.

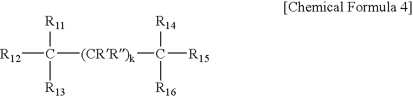

wherein R₁₁ to R₁₆ are the same or different, and are selected from the group consisting of hydrogen, a halogen, a substituted or unsubstituted alkyl, a substituted or unsubstituted aryl, and AₓR_{y}, where A is N, O, P or S, R is selected from the group consisting of CN, a substituted or unsubstituted alkyl, and carboxyl, x is 0 or 1, y is determined according to the valance of A, and k ranges from 0 to 10, with the proviso that at least two of R₁₁ to R₁₄ are CN.

CN—R₁₈—CN [Chemical Formula 5]

wherein R₁₈ is an aromatic cycle, an aromatic heterocycle, or an aliphatic cycle, with the proviso that CN is connected to an adjacent carbon in the cycle.

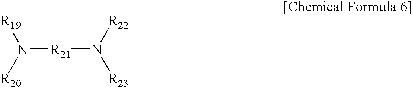

wherein R₁₉, R₂₁, R₂₂, and R₂₃ are the same or different, and are selected from the group consisting of hydrogen, a halogen, a substituted or unsubstituted alkyl, a substituted or unsubstituted aryl and AₓR_{y}, where A is N, O, P or S, R is selected from the group consisting of CN, a substituted or unsubstituted alkyl, and carboxyl, x is 0 or 1, and y is determined according to the valance of A, R₂₁ is selected from the group consisting of an alkylene, a cycloalkylene, and an arylene, with the proviso that at least two of R₁₉, R₂₁, R₂₂, and R₂₃ are CN.

The rechargeable lithium battery of the present invention included an additive in a non-aqueous electrolyte and thereby, can have increased initial formation efficiency and improved cycle-life characteristic.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components.

FIG. 1 is a schematic cross-sectional view of a rechargeable lithium battery according to one embodiment of the present invention.

FIG. 2 is a graph showing capacity retention of battery cells according to Examples 1, 3, and 4 and Comparative Example 1.

FIG. 3 is a graph showing change open circuit voltage (OCV) change of a battery cells according to Example 8 and Comparative Examples 4 and 5 after they are allowed to stand at a high temperature of 60° C.

### DETAILED DESCRIPTION OF THE INVENTION

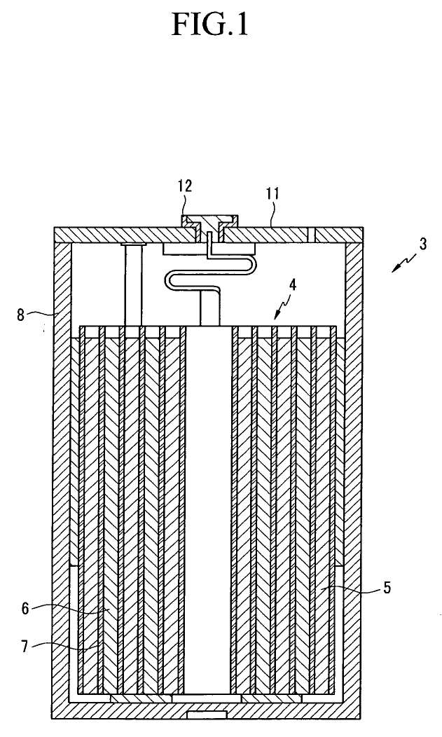

The present invention relate to an electrolyte of a non-aqueous lithium battery. A general structure of the non-aqueous rechargeable lithium battery 1 is illustrated in FIG. 1.

Referring to FIG. 1, the rechargeable lithium battery 1 according to one embodiment, the rechargeable lithium battery 1 is fabricated by placing the electrode assembly 4 including the positive electrode 5, the negative electrode 6, and the separator 7 interposed between the positive electrode 5 and the negative electrode 6 inside the case 8, then injecting an electrolyte through the upper of the case 8, and sealing the case 8 by the cap plate 11 and the gasket 12. Rechargeable lithium batteries may be divided into lithium ion batteries, lithium ion polymer batteries, and lithium polymer batteries according to the presence of a separator and the kind of electrolyte used in the battery. The rechargeable lithium batteries may be formed a variety of shapes and sizes, a cylindrical shape, a prismatic shape, and a coin-type. They may be a thin film battery or be rather bulky in size. The structures and the fabricating methods for lithium ion batteries are well known in the art.

The rechargeable lithium battery includes a positive electrode including a positive active material that can reversely intercalate/deintercalate lithium ions, a negative electrode including a negative active material represented by the following Formula 1, and a non-aqueous electrolyte including a non-aqueous organic solvent and a lithium salt.

Herein, an embodiment of the present invention includes a LVO-based compound as the negative active material and the non-aqueous electrolyte to which an additive is added. the additive can increase initial formation efficiency of a rechargeable lithium battery and improve cycle-life characteristic thereof.

The present invention includes a compound represented by the following formula 1 as the negative active material:

LiₓM_{y}V_{z}O_{2+d} [Chemical Formula 1]

wherein 0.1≦x≦2.5, 0≦y≦0.5, 0.5≦z≦1.5, 0≦d≦0.5, and M is a metal selected from the group consisting of Al, Cr, Mo, Ti, W, Zr, and combinations thereof.

When the compound of the above Formula 1 is used as a negative active material, it can make the density of the electrode higher than a conventional graphite-based material do. In general, a negative active material works as a critical factor increasing energy density in a battery having limited capacity per weight rather than limited capacity per weight. Accordingly, the compound represented by Chemical Formula 1 can have a great effect as a negative active material.

If needed, the negative active material according to the above Chemical Formula 1 can be mixed with a general negative active material, for example, lithium metal or lithium alloy, coke, artificial graphite, natural graphite, a combusted organic polymer compound, carbon fiber, and the like, as a second negative active material. According to one embodiment of the present invention, it can be mixed with a graphite-based material including artificial graphite, natural graphite, or the like. These additional second negative active materials may be included in an amount of equal to or less than 100 parts by weight based on 100 parts by weight of the first negative active material of Chemical Formula 1. It can be included preferably in an amount of 10 to 80 parts by weight and more preferably 10 to 50 parts by weight. For example, the second negative active material may be included in an amount of 15, 25, 35, 45, 55, 65, 75, and 85 parts by weight based on 100 parts by weight of the first negative active material. The combination of the first negative active material and the second negative active material in the above mixing range improves electrode density and thus capacity.

Then, this negative active material is mixed with a binder and optionally, a conductive agent to prepare a composition for a negative active material layer. The composition for a negative active material layer is coated on a negative current collector to prepare a negative electrode.

The binder may be a non-aqueous binder such as diacetylene cellulose, polyvinylchloride, polyvinylpyrrolidone, polytetrafluoroethylene, polyvinylidene fluoride, polyethylene, polypropylene, and combinations thereof. The composition for a negative active material layer includes a non-aqueous solvent such as N-methyl-2-pyrrolidone (NMP), dimethylformamide and tetrahydrofuran,

Any electrically conductive material may be used as a conductive agent unless it causes any chemical change. Examples of the conductive agent include natural graphite, artificial graphite, carbon black, acetylene black, ketjen black, carbon fiber, a metal powder or a metal fiber including copper, nickel, aluminum, silver, and so on, a polyphenylene derivative, or combinations thereof.

The current collector may be selected from the group consisting of a copper foil, a nickel foil, a stainless steel foil, a titanium foil, a nickel foam, a copper foam, a polymer substrate coated with a conductive metal, and combinations thereof.

The negative active material of the above Formula 1 can improve battery capacity but increases a positive electrode potential so that a battery may be unstable during full-charge relative to graphite. Therefore, according to one embodiment of the present invention, a compound having an electron donating group including a nitrogen atom is added to a non-aqueous electrolyte of a rechargeable lithium battery. The combination of the negative active material of the Formula 1 and the additive having an electron donating group including a nitrogen atom can improve capacity, cycle-life, and high temperature characteristics of a rechargeable lithium battery. For example, the electron donating group including a nitrogen atom includes, but is not limited to, a cyano group.

The terms of the additive represented by the following chemical formulae are defined as below.

In this specification, a halogen refers to F, Cl, Br, or I. An alkyl refers to a substituted or unsubstituted linear or branched C1 to C30 alkyl. An alkyl refers to a C1 to C15 alkyl. A lower alkyl refers to a C1 to C7 alkyl. An aryl refers to a substituted or unsubstituted C6 to C30 aryl. An aryl refers to a C6 to C15 aryl. An alkylene refers to a C1 to C10 alkylene, a cycloalkylene refers to a C3 to C20 cycloalkylene, and an arylene refers to a C6 to C20 arylene. An aromatic cycle refers to a substituted or unsubstituted C6 to C30 aromatic cyclic compound and the aromatic cycle may be a C6 to C15 aromatic cyclic compound. An aromatic heterocyclic compound refers to a substituted or unsubstituted C2 to C30 aromatic hetero cyclic compound, and in one embodiment the aromatic heterocyclic compound refers to a C4 to C15 aromatic hetero cyclic compound. The hetero cyclic compound includes 1 to 3 heteroatoms of nitrogen (N), oxygen (O), sulfur (S), or phosphorus (P) instead of at least one carbon member of a cycle ring. An aliphatic cyclic compound refers to a substituted or unsubstituted C3 to C30 aliphatic cyclic compound, and in one embodiment, the aliphatic cyclic compound may be a C3 to C15 aliphatic cyclic compound.

In this specification, the term “substituted” means that hydrogen is substituted by an alkyl, an alkenyl, a halogen, an amine, or an aryl.

According to one embodiment of the present invention, the compounds represented by the following Formulae 2 to 6 may be used as an additive.

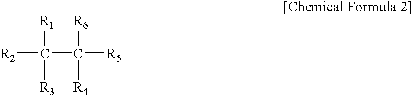

wherein R₁ to R₆ are the same or different, and are selected from the group consisting of hydrogen, a halogen, a substituted or unsubstituted alkyl, a substituted or unsubstituted aryl, and AₓR_{y}, where A is N, O, P or S, R is selected from the group consisting of CN, a substituted or unsubstituted alkyl, and carboxyl, x is 0 or 1, and y is determined according to the valance of A, while ranging from 1 to 5, with the proviso that at least two of R₁ to R₆ are CN. In one embodiment, at least one of R₁ to R₃ and at least one of R₄ to R₆ are CN.

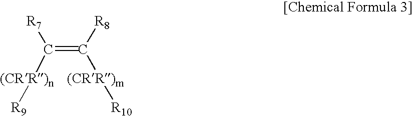

wherein R₇ to R₁₀ are the same or different, and are selected from the group consisting of hydrogen, a halogen, a substituted or unsubstituted alkyl, a substituted or unsubstituted aryl, and AₓR_{y}, where A is N, O, P or S, R is selected from the group consisting of CN, a substituted or unsubstituted alkyl, and carboxyl, x is 0 or 1, and y is determined according to the valance of A, while ranging from 1 to 5, R′ and R″ are independently hydrogen or a lower alkyl, and n and m are an integer ranging from 0 to 10, with the proviso that at least two of R₇ to R₁₀ are CN. In one embodiment, at least one of R₇ and R₉ and at least one of R₈ and R₁₀ are CN.

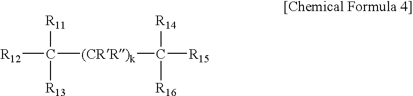

wherein R₁ to R₁₆ are the same or different, and are selected from the group consisting of hydrogen, a halogen, a substituted or unsubstituted alkyl, a substituted or unsubstituted aryl, and AₓR_{y}, where A is N, O, P or S, R is selected from the group consisting of CN, a substituted or unsubstituted alkyl, and carboxyl, x is 0 or 1, y is determined according to the valance of A, while ranging from 1 to 5, and k ranges from 0 to 10, with the proviso that at least two of R₁₁ to R₁₄ are CN. In one embodiment, at least one of R₁₁ to R₁₃ and at least one of R₁₄ to R₁₆ are CN.

CN—R₁₈—CN [Chemical Formula 5]

wherein R₁₈ is an aromatic cycle, an aromatic heterocycle, or an aliphatic cycle, with the proviso that CN is connected to an adjacent carbon in the cycle.

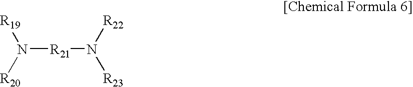

wherein R₁₉, R₂₁, R₂₂, and R₂₃ are the same or different, and are selected from the group consisting of hydrogen, a halogen, a substituted or unsubstituted alkyl, a substituted or unsubstituted aryl and AₓR_{y}, where A is N, O, P or S, R is selected from the group consisting of CN, a substituted or unsubstituted alkyl, and carboxyl, x is 0 or 1, and y is determined according to the valance of A, while ranging from 1 to 5, R₂₁ is selected from the group consisting of alkylene, cycloalkylene, and arylene, with the proviso that at least two of R₁₉, R₂₁, R₂₂, and R₂₃ are CN.

In one embodiment, R₁₈ of the above Formula 5 may be a substituted or unsubstituted benzyl or cyclohexyl.

In another embodiment, the additive compound may be compound represented by the following Formulae 7 to 12 or mixtures thereof:

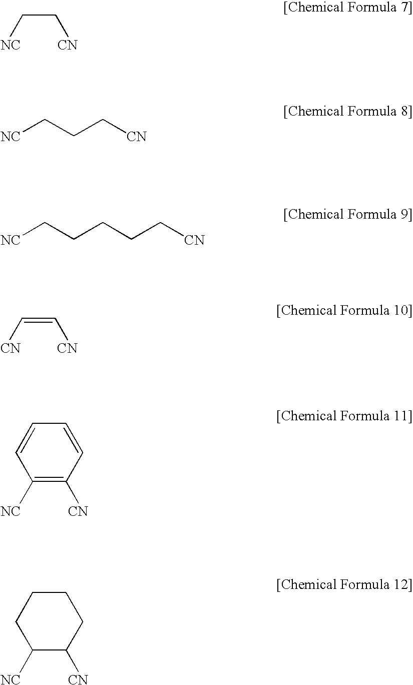

In general, a non-aqueous organic solvent plays a role of a medium through which ions participating in electrochemical reaction of a rechargeable lithium battery can transfer. Herein, an additive is added to the non-aqueous organic solvent and thereby, can have an effect on maintaining a high voltage. In addition, the additive tends to be stable at 2.5 to 4.8V and can form a complex by chelating a metal. As a result, the additive catches a metal, and the metal can be extracted on the surface of a negative electrode so that the additive can prevent voltage drop and safety deterioration due to internal short-circuit and particularly, can have excellent effects on securing safety when a battery is left at a high temperature.

In other words, when LiCoO₂ is used as a positive active material, there are two different kinds of cobalt oxides such as Co (III) and Co (IV) at a positive electrode during the charge. The quadrivalent cobalt is so unstable that it may strongly tend to react with an electrolyte solution and to be separated from a lattice for reduction. Herein, an additive according to the present invention, that is, a dinitrile-based compound can work for stabilization of the quadrivalent cobalt. As a result, an additive according to the present invention plays a role of suppressing a negative reaction with an electrolyte solution and thereby, improving efficiency, contributing to cycle-life characteristic in the long term. A conventional additive with one cyano group (CN) may bring about the same effects. However, since the conventional additive has a mono dentate, it is labile so that it may easily lose stability. However, an additive having at least two electron donating group can coordinate stability and thereby, have better effects than the conventional one.

The additive compound may be included in an amount of 0.1 to 10 wt % based on the total weight of a non-aqueous electrolyte, but according to another embodiment of the present invention, it may be included in an amount of 1 to 5 wt % and according to further another embodiment, it may be included in an amount of 2 to 5 wt % based on the total weight of a non-aqueous electrolyte. In further embodiment, the additive compound may be included in an amount of 1.5, 2.5, 3.5, 4.5, 5.5, 6.5, or 7.5 wt %. When the additive is included in an amount of less than 0.1 wt %, it may have little effects, while when it is added in an amount of more than 10 wt %, it may cause a problem in a charge and discharge cycle-life.

In addition to the additive, a rechargeable lithium battery of the present invention may further include an eluting additive for eluting transition elements from a positive electrode. Accordingly, when the additive is used with the eluting additive, they can completely convert an overcharge mode caused by an internal short-circuit into a shut-down mode, securing overcharge stability.

The eluting additive can be an ester-based compound but may be at least one selected from the group consisting of phenyl acetate, benzyl benzoate, ethyl acetate, 1-naphthylacetate, 2-chromanone, and ethyl propinonate.

The eluting additive may be included in an amount of 1 to 10 parts by weight based on the entire 100 parts by weight of a non-aqueous electrolyte. However, according to another embodiment of the present invention, it may be included in an amount of 1 to 7 parts by weight, and according to still another embodiment, it may be included in an amount of 3 to 5 parts by weight. When the eluting additive is included in an amount of less than 1 part by weight, it cannot have an effect of suppressing overcharge. On the other hand, when it is included in an amount of more than 10 parts by weight, it may deteriorate cycle-life characteristic.

The non-aqueous electrolyte includes a lithium salt and a non-aqueous organic solvent.

The lithium salt supplies lithium ions in the battery and operates a basic operation of a rechargeable lithium battery. The non-aqueous organic solvent acts as a medium for transmitting ions taking part in the electrochemical reaction of the battery.

Non-limiting examples of the lithium salt include at least one supporting electrolyte salt selected from the group consisting of LiPF₆, LiBF₄, LiSbF₆, LiAsF₆, LiClO₄, LiCF₃SO₃, LiC₄F₉SO₃, LiN(CF₃SO₂)₂, LiN(C₂F₅SO₂)₂, LiAlO₄, LiAlCl₄, LiN(CₚF₂ₚ₊₁SO₂)(C_{q}F_{2q+1}SO₂) (where p and q are natural numbers), LiSO₃CF₃, LiCl, LiI, lithium bisoxalate borate, and combinations thereof.

The lithium salt may be used at a 0.6 to 2.0M. According to one embodiment, the lithium salt may be used at a 0.7 to 1.6 M. When the lithium salt concentration is less than 0.6M, electrolyte performance may be deteriorated due to low electrolyte conductivity, whereas when it is more than 2.0M, lithium ion mobility may be reduced due to an increase of electrolyte viscosity.

The non-aqueous organic solvent may include a carbonate-based, ester-based, ether-based, ketone-based, alcohol-based solvent, or combinations thereof. Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethylcarbonate (MEC), ethylene carbonate (EC), propylene carbonate (PC), butylene carbonate (BC), and so on. Examples of the ester-based solvent may include n-methyl acetate, n-ethyl acetate, n-propyl acetate, and so on.

The carbonate-based solvent may include a mixture of a cyclic carbonate and a chain carbonate. When the cyclic carbonate and the chain carbonate are mixed together in a volume ratio of 1:1 to 1:9, and the mixture is used as an electrolyte, the electrolyte performance may be enhanced.

The electrolyte according to one embodiment of the present invention may include mixtures of carbonate-based solvents and aromatic hydrocarbon-based solvents. The aromatic hydrocarbon-based organic solvent may be represented by the following Formula 13:

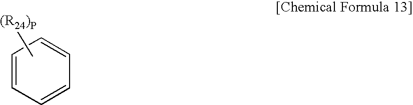

wherein R₂₄ is a halogen or a C1 to C10 alkyl, and p is an integer ranging from 0 to 6.

The aromatic hydrocarbon-based organic solvent may include, but is not limited to, at least one selected from the group consisting of benzene, fluorobenzene, toluene, fluorotoluene, trifluorotoluene, chlorotoluene, xylene and combinations thereof.

The electrolyte may further include an additive selected from the group consisting of a carbonate having a substituent selected from the group consisting of a halogen, a nitrile (CN) and a nitro (NO₂), vinylene carbonate, divinylsulfone, and ethylene sulfite.

When this additive is included in an electrolyte, it can contribute to providing a lithium rechargeable battery with excellent electrochemical characteristic such as high temperature swelling characteristic, capacity, cycle-life, low temperature characteristic, and the like. Among the above additives, a carbonate additive may be included to fabricate a lithium rechargeable battery according to the present invention. The carbonate additive may include an ethylene carbonate derivative represented by the following Formula 14 and a fluoroethylene carbonate.

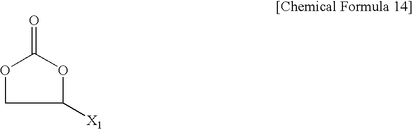

wherein X₁ is selected from the group consisting of a halogen, a cyano (CN), and a nitro (NO₂).

According to one embodiment of the present invention, a non-aqueous electrolyte may be prepared by adding a lithium salt and the additive to a non-aqueous organic solvent. In general, the additive is added to an organic solvent in which a lithium salt is dissolved, but the order to add a lithium salt and an electrolyte additive is not important.

The positive electrode of the rechargeable lithium battery includes a positive active material. The positive active material includes a lithiated intercalation compound capable of reversibly intercalating and deintercalating lithium ions.

Specifically, the positive active material includes a composite oxide including lithium and a metal selected from the group consisting of cobalt, manganese, nickel, and combinations thereof, and is more specifically exemplified by compounds of the following Chemical Formulae 15 to 38:

LiₐA′_{1-b}B′_{b}D′₂ [Chemical Formula 15]

wherein A′ is selected from the group consisting of Ni, Co, Mn, and combinations thereof, B′ is selected from the group consisting of Al, Ni, Co, Mn, Cr, Fe, Mg, Sr, V, a rare earth element, and combinations thereof, D′ is selected from the group consisting of O, F, S, P, and combinations thereof, 0.95≦a≦1.1, and 0≦b≦0.5.

LiₐE′_{1-b}B′_{b}O_{2-c}F′_{c} [Chemical Formula 16]

Wherein B′ is selected from the group consisting of Al, Ni, Co, Mn, Cr, Fe, Mg, Sr, V, a rare earth element, and combinations thereof, E′ is selected from the group consisting of Co, Mn, and combinations thereof, F′ is selected from the group consisting of F, S, P, and combinations thereof, 0.95≦a≦1.1, 0≦b≦0.5, and 0≦c≦0.05.

LiE′_{2-b}B′_{b}O_{4-c}F′_{c} [Chemical Formula 17]

Wherein B′ is selected from the group consisting of Al, Ni, Co, Mn, Cr, Fe, Mg, Sr, V, a rare earth element, and combinations thereof, E′ is selected from the group consisting of Co, Mn, and combinations thereof, F′ is selected from the group consisting of F, S, P, and combinations thereof, 0≦b≦0.5, and 0≦c≦0.05.

LiₐNi_{1-b-c}Co_{b}B′_{c}D′_{α} [Chemical Formula 18]

wherein B′ is selected from the group consisting of Al, Ni, Co, Mn, Cr, Fe, Mg, Sr, V, a rare earth element, and combinations thereof, D′ is selected from the group consisting of O, F, S, P, and combinations thereof, 0.95≦a≦1.1, 0≦b≦0.5, 0≦c≦0.05, and 0≦α≦2.

LiₐNi_{1-b-c}Co_{b}B′_{c}O₂₋ₐF′_{α} [Chemical Formula 19]

wherein B′ is selected from the group consisting of Al, Ni, Co, Mn, Cr, Fe, Mg, Sr, V, a rare earth element, and combinations thereof, F′ is selected from the group consisting of F, S, P, and combinations thereof, 0.95≦a≦1.1, 0≦b≦0.5, 0≦c≦0.05, and 0≦α≦2.

LiₐNi_{1-b-c}Co_{b}B′_{c}O_{2-α}F′₂ [Chemical Formula 20]

wherein B′ is selected from the group consisting of Al, Ni, Co, Mn, Cr, Fe, Mg, Sr, V, a rare earth element, and combinations thereof, F′ is selected from the group consisting of F, S, P, and combinations thereof, 0.95≦a≦1.1, 0≦b≦0.5, 0≦c≦0.05, and 0≦α≦2.

LiₐNi_{1-b-c}Mn_{b}B′_{c}D′_{α} [Chemical Formula 21]

wherein B′ is selected from the group consisting of Al, Ni, Co, Mn, Cr, Fe, Mg, Sr, V, a rare earth element, and combinations thereof, D′ is selected from the group consisting of O, F, S, P, and combinations thereof, 0.95≦a≦1.1, 0≦b≦0.5, 0≦c≦0.05, and 0<α≦2.

LiₐNi_{1-b-c}Mn_{b}B′_{c}O_{2-α}F′_{α} [Chemical Formula 22]

wherein B′ is selected from the group consisting of Al, Ni, Co, Mn, Cr, Fe, Mg, Sr, V, a rare earth element, and combinations thereof, F′ is selected from the group consisting of F, S, P, and combinations thereof, 0.95≦a≦1.1, 0≦b≦0.5, 0≦c≦0.05, and 0<α<2.

LiₐNi_{1-b-c}Mn_{b}B′_{c}O_{2-α}F₂ [Chemical Formula 23]

wherein B′ is selected from the group consisting of Al, Ni, Co, Mn, Cr, Fe, Mg, Sr, V, a rare earth element, and combinations thereof, F′ is selected from the group consisting of F, S, P, and combinations thereof, 0.95≦a≦1.1, 0≦s≦0.5, 0≦c≦0.05, and 0<α<2.

LiₐNi_{b}E′_{c}G′_{d}O₂ [Chemical Formula 24]

wherein E′ is selected from the group consisting of Co, Mn, and combinations thereof, G′ is selected from the group consisting of Al, Cr, Mn, Fe, Mg, La, Ce, Sr, V, and combinations thereof, 0.90≦a≦1.1, 0≦b≦0.9, 0≦c≦0.5, and 0.001≦d≦0.1.

LiₐNi_{b}Co_{c}Mn_{d}G′ₑO₂ [Chemical Formula 25]

Wherein G′ is selected from the group consisting of Al, Cr, Mn, Fe, Mg, La, Ce, Sr, V, and combinations thereof, 0.90≦a≦1.1, 0≦b≦0.9, 0≦c≦0.5, 0≦d≦0.5, and 0.001≦e≦0.1.

LiₐNiG′_{b}O₂ [Chemical Formula 26]

wherein G′ is selected from the group consisting of Al, Cr, Mn, Fe, Mg, La, Ce, Sr, V, and combinations thereof, 0.90≦a≦1.1, and 0.001≦b≦0.1.

LiₐCoG′_{b}O₂ [Chemical Formula 27]

wherein G′ is selected from the group consisting of Al, Cr, Mn, Fe, Mg, La, Ce, Sr, V, and combinations thereof, 0.90≦a≦1.1, and 0.001≦b≦0.1.

LiₐMnG′_{b}O₂ [Chemical Formula 28]

wherein G′ is selected from the group consisting of Al, Cr, Mn, Fe, Mg, La, Ce, Sr, V, and combinations thereof, 0.90≦a≦1.1, and 0.001≦b≦0.1.

LiₐMn₂G′_{b}O₄ [Chemical Formula 29]

wherein G′ is selected from the group consisting of Al, Cr, Mn, Fe, Mg, La, Ce, Sr, V, and combinations thereof, 0.90≦a=1.1, and 0.001≦b≦0.1.

QO₂ [Chemical Formula 30]

wherein Q is selected from the group consisting of Ti, Mo, Mn, and combinations thereof.

QS₂ [Chemical Formula 31]

wherein Q is selected from the group consisting of Ti, Mo, Mn, and combinations thereof.

LiQS₂ [Chemical Formula 32]

wherein Q is selected from the group consisting of Ti, Mo, Mn, and combinations thereof.

V₂O₅ [Chemical Formula 33]

LiV₂O₅ [Chemical Formula 34]

LiIO₂ [Chemical Formula 35]

wherein I is selected from the group consisting of Cr, V, Fe, Sc, Y, and combinations thereof.

LiNiVO₄ [Chemical Formula 36]

Li_{(3-f)}J′₂(PO₄)₃ [Chemical Formula 37]

wherein J′ is selected from the group consisting of V, Cr, Mn, Co, Ni, Cu, and combinations thereof and 0≦f≦3.

Li_{(3-f)}Fe₂(PO₄)₃ [Chemical Formula 38]

wherein 0≦f≦2.

In addition, the positive active material may include inorganic sulfur (S₈, elemental sulfur) and a sulfur-based compound. The sulfur-based compound may include Li₂Sₙ (n≧1), Li₂Sₙ (n≧1) dissolved in a catholyte, an organic sulfur compound, a carbon-sulfur polymer ((C2S_{f})ₙ where f=2.5 to 50 and n≧2), or the like.

Like the negative electrode, the positive electrode can be prepared by mixing the positive active material, a binder, and optionally, a conductive agent to prepare a composition for a positive active material layer and then, coating the composition for a positive active material layer on a positive current collector such as aluminum and the like.

The following examples illustrate the present invention in more detail. However, it is understood that the present invention is not limited by these examples.

Half-Cell Fabrication

### EXAMPLE 1

90 wt % of Li_{1.1}V_{0.89}Ti_{0.01}O₂ as a negative active material, 5 wt % of a graphite conductive agent, 5 wt % of a polytetrafluoroethylene binder were mixed in an N-methylpyrrolidone solvent, preparing negative active material slurry. The negative active material slurry was coated on a copper foil current collector, to fabricate a negative electrode. Herein, the prepared negative electrode had an active mass density (a mixture of an active material, a conductive agent, and a binder forming an active material layer on a current collector) of 2.4 g/cc.

The negative electrode was used as a working electrode, while lithium was used as a counter electrode. A porous polypropylene film separator was interposed between the working and counter electrodes, and thereafter, an electrolyte solution was injected, preparing a coin type cell.

Herein, the electrolyte solution was prepared by mixing propylene carbonate (PC), diethyl carbonate (DEC), and ethylene carbonate (EC) in a volume ratio of 1:1:1, adding 0.1 wt % of ethylene dicyanide as an additive to the mixed solvent, and then, dissolving LiPF₆ to prepare 1 M of LiPF.

### EXAMPLE 2

A coin-type cell was fabricated according to the same method as in Example 1 except for preparing an electrolyte solution by mixing PC, DEC, and EC in a volume ratio of 1:1:1 and adding 5 wt % of ethylene dicyanide.

### EXAMPLE 3

A coin-type cell was fabricated according to the same method as in Example 1 except for preparing an electrolyte solution by mixing PC, DEC, and EC in a volume ratio of 1:1:1 and adding 10 wt % of ethylene dicyanide.

### EXAMPLE 4

A coin-type cell was fabricated according to the same method as in Example 1 except for using glutaronitrile instead of ethylene dicyanide as an additive.

### EXAMPLE 5

A coin-type cell was fabricated according to the same method as in Example 1 except for using adiponitrile instead of ethylene dicyanide as an additive.

### EXAMPLE 6

A coin-type cell was fabricated according to the same method as in Example 1 except that a negative active material was prepared by mixing Li_{1.1}V_{0.89}Ti_{0.01}O₂ and artificial graphite in a weight ratio of 2:1.

### EXAMPLE 7

A coin-type cell was fabricated according to the same method as in Example 1 except for using succinonitrile instead of ethylene dicyanide as an additive.

### COMPARATIVE EXAMPLE 1

A coin-type half cell was fabricated according to the same method as in Example 1 except for using a non-aqueous electrolyte solution without an ethylene dicyanide additive.

### COMPARATIVE EXAMPLE 2

A coin-type cell was fabricated according to the same method as in Comparative Example 1 except using MCF graphite as a negative active material.

### COMPARATIVE EXAMPLE 3

A coin-type cell was fabricated according to the same method as in Comparative Example 1 except using MCF graphite as a negative active material and a non-aqueous electrolyte solution including 0.1 wt % succinonitrile.

Full Cell Fabrication

### EXAMPLE 8

95 wt % of LiCoO₂ as a positive active material, 2 wt % of SUPER P as a conductive agent, and 3 wt % of polyvinylidene fluoride (PVdF) as a binder were mixed in an N-methyl pyrrolidone solvent, preparing a positive active material slurry. The positive active material slurry was coated on an aluminum foil to fabricate a positive electrode.

A battery cell was fabricated using the negative electrode fabricated in Example 1 and the above fabricated positive electrode. A porous polypropylene film was used for a separator. An electrolyte solution including 1M LiPF₆ dissolved in a mixed solvent of propylene carbonate (PC), diethyl carbonate (DEC) and ethylene carbonate (EC) in a 1:1:1 volume ratio and 5 wt % of succinonitrile was used.

### COMPARATIVE EXAMPLE 4

A battery cell was fabricated according to the same method as in Example 8 except for using an electrolyte solution without the succinonitrile.

### COMPARATIVE EXAMPLE 5

A battery cell was fabricated according to the same method as in Example 8 except for using MCF graphite for a negative active material and an electrolyte solution without the succinonitrile.

### COMPARATIVE EXAMPLE 6

A battery cell was fabricated according to the same method as in Example 8 except for using MCF graphite for a negative active material and an electrolyte solution including 0.1 wt % of succinonitrile.

### EXPERIMENTAL EXAMPLE 1

### Initial Formation Charge/Discharge Capacity of Cells

The cells fabricated according to Examples 1 to 7 and Comparative Examples 1 to 3 were allowed to stand for 12 hours at room temperature and then, once charged and discharged at a 0.1 C rate to measure their initial formation capacity. The charge and discharge capacities and initial efficiency of the cells according to Examples 1 to 5 and Comparative Examples 1 and 2 are shown in the following Table 1.

TABLE 1

| | Formation | | |
|---|---|---|---|
| | charge | Formation discharge | Initial |
| | capacity | capacity | Efficiency |
| | (mAh/cc) | (mAh/cc) | (%) |
| Example 1 | 696.0 | 645.1 | 92.7 |
| Example 2 | 697.0 | 643.5 | 92.3 |
| Example 3 | 696.4 | 641.7 | 92.1 |
| Example 4 | 695.9 | 639.8 | 91.9 |
| Example 5 | 695.7 | 641.5 | 92.2 |
| Comparative Example 1 | 695.7 | 621.0 | 89.3 |
| Comparative Example 2 | 589.5 | 557.0 | 94.5 |

Referring to Table 1, the cells according to Examples 1 to 5 of the present invention included a dinitrile compound as an additive and thereby, turned out to have higher charge and discharge characteristic than the ones of Comparative Examples 1 and 2 not including this additive. Comparative Example 2 had relatively high initial efficiency but very low charge and discharge capacities of each 589.5 mAh/cc and 557.0 mAh/cc.

### EXPERIMENTAL EXAMPLE 2

### Cycle-Life Characteristic Analysis of Cells

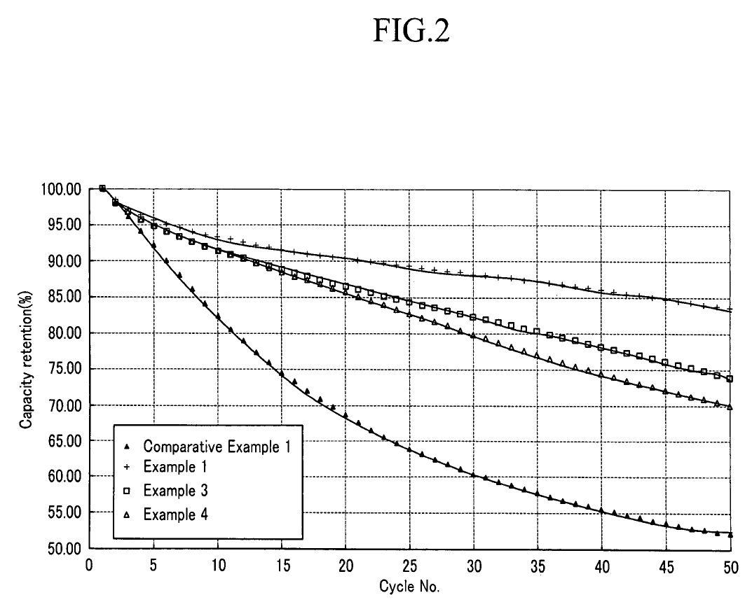

The cells according to Examples 1 to 7 and Comparative Examples 1 to 3 were 50 times charged and discharged at a 1 C rate. Then, their initial capacity retention was measured. The results of the cells according to Examples 1, 3, and 4, and Comparative Example 1 are shown in the following Table 2 and FIG. 2.

TABLE 2

| | Capacity retention after 50 cycles (%) |
|---|---|
| Example 1 | 83.51 |
| Example 3 | 73.94 |
| Example 4 | 70.09 |
| Comparative | 52.18 |
| Example 1 | |

Referring to Table 2 and FIG. 2, the cells of Examples 1, 3 and 4 included a dinitrile compound as an additive and thereby, higher cycle-life characteristic than the one of Comparative Example 1. The cells according to Examples 2 and 5 showed similar results to those of Examples 1, 3, and 4.

### EXPERIMENTAL EXAMPLE 3

### Cycle-Life Characteristic Analysis

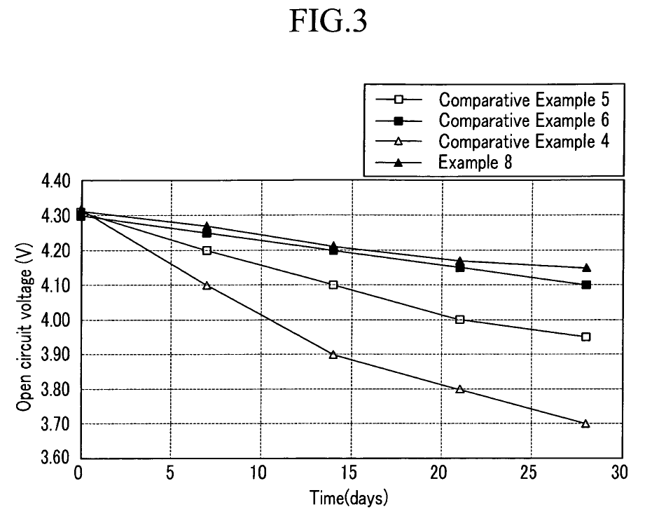

The cells fabricated according to Example 8 and Comparative Examples 4 to 6 were allowed to stand at 60° C. for a long time and then open circuit voltages (OCV) were measured. The results are shown in FIG. 3.

Referring to FIG. 3, the cell according to Comparative Example 4 including a Li_{1.1}V_{0.89}Ti_{0.01}O₂ negative electrode showed OCV that was sharply decreased at high temperature. On the contrary, the cell according to Example 8 including a dinitrile additive compound showed OCV of 4V or more. Referring to the cell including the graphite negative electrode according to Comparative Example 5 and the cell including the dinitrile compound additive according to Comparative Example 6, the cell according to Comparative Example 6 shows an increase of OCV relative to the cell according to Comparative Example 5, but, compared with the increase in Example 8, the increased amount is small. Accordingly, high temperature cell characteristics are improved when the dinitrile additive compound is used with a Li_{1.1}V₀₈₉Ti_{0.01}O₂ negative electrode.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rechargeable lithium battery comprising
a positive electrode comprising a positive active material capable of reversely intercalating/deintercalating lithium ions;
a negative electrode comprising a negative electrode active material comprising a compound represented by Formula 1:
LiₓM_{y}V_{z}O_{2+d} (1)
wherein 0.1≦x≦2.5, 0≦y≦0.5, 0.5≦z≦1.5, 0≦d≦0.5, and M is a metal selected from the group consisting of Al, Cr, Mo, Ti, W, Zr and combinations thereof; and
a non-aqueous electrolyte comprising a non-aqueous organic solvent, a lithium salt, and at least one additive compound represented by one of Formulae 2 to 6: 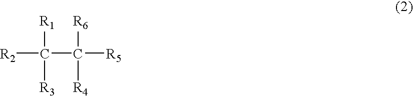
wherein R₁ to R₆ are the same or different, and are selected from the group consisting of hydrogen, a halogen, a substituted or unsubstituted alkyl, a substituted or unsubstituted aryl, and AₓR_{y}, where A is N, O, P or S, R is selected from the group consisting of CN, a substituted or unsubstituted alkyl, and carboxyl, x is 0 or 1, and y is determined according to the valance of A, with the proviso that at least two of R₁ to R₆ are CN; 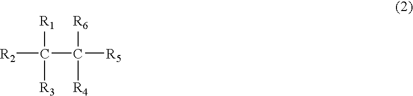
wherein R₁ to R₆ are the same or different, and are selected from the group consisting of hydrogen, a halogen, a substituted or unsubstituted alkyl, a substituted or unsubstituted aryl, and AₓR_{y}, where A is N, O, P or S, R is selected from the group consisting of CN, a substituted or unsubstituted alkyl, and carboxyl, x is 0 or 1, and y is determined according to the valance of A, with the proviso that at least two of R₁ to R₆ are CN; 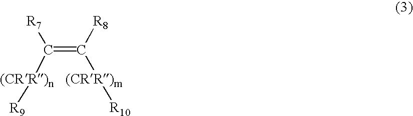
wherein R₇ to R₁₀ are the same or different, and are selected from the group consisting of hydrogen, a halogen, a substituted or unsubstituted alkyl, a substituted or unsubstituted aryl, and AₓR_{y}, where A is N, O, P or S, R is selected from the group consisting of CN, a substituted or unsubstituted alkyl, and carboxyl, x is 0 or 1, and y is determined according to the valance of A, R′ and R″ are independently hydrogen or a lower alkyl, and n and m are an integer ranging from 0 to 10, with the proviso that at least two of R₇ to R₁₀ are CN; 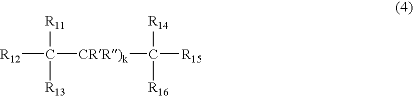
wherein R₁₁ to R₁₆ are the same or different, and are selected from the group consisting of hydrogen, a halogen, a substituted or unsubstituted alkyl, a substituted or unsubstituted aryl, and AₓR_{y}, where A is N, O, P or S, R is selected from the group consisting of CN, a substituted or unsubstituted alkyl, and carboxyl, x is 0 or 1, y is determined according to the valance of A, and k ranges from 0 to 10, with the proviso that at least two of R₁₁ to R₁₄ are CN;
CN—R₁₈—CN (5)
wherein R₁₈ is an aromatic cycle, an aromatic heterocycle, or an aliphatic cycle, with the proviso that two cyano groups are connected to adjacent carbons of the cycle; and 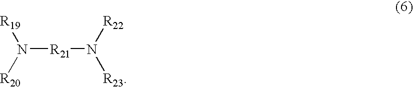
wherein R₁₉, R₂₁, R₂₂, and R₂₃ are the same or different, and are selected from the group consisting of hydrogen, a halogen, a substituted or unsubstituted alkyl, a substituted or unsubstituted aryl and AₓR_{y}, where A is N, O, P or S, R is selected from the group consisting of CN, a substituted or unsubstituted alkyl, and carboxyl, x is 0 or 1, and y is determined according to the valance of A, R₂₁ is selected from the group consisting of an alkylene, a cycloalkylene, and an arylene, with the proviso that at least two of R₁₉, R₂₁, R₂₂, and R₂₃ are CN.

2. The rechargeable lithium battery of claim 1, wherein said at least one additive compound is at least one compound represented by one of Formulae 7 to 12 and or mixtures thereof:

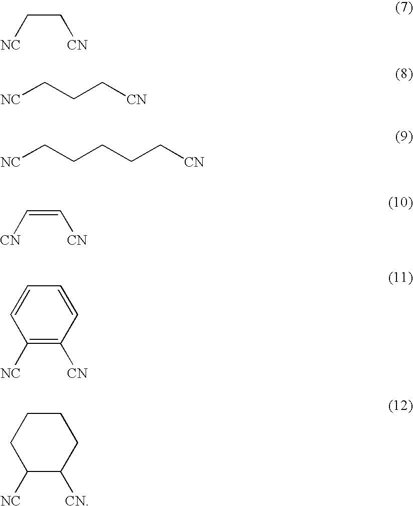

3. The rechargeable lithium battery of claim 1, wherein the additive compound is included in an amount of 0.1 to 10 wt % based on the total weight of the non-aqueous electrolyte.

4. The rechargeable lithium battery of claim 1, wherein the additive compound is included in an amount of 1 to 5 wt % based on the total weight of the non-aqueous electrolyte.

5. The rechargeable lithium battery of claim 1, wherein the additive compound is included in an amount of 2 to 5 wt % based on the total weight of the electrolyte.

6. The rechargeable lithium battery of claim 1, wherein the negative active material further comprises graphite-based material selected from the group consisting of natural graphite, artificial graphite, and a combination thereof.

7. The rechargeable lithium battery of claim 6, wherein the graphite-based material is included in amount of 100 parts by weight or less based on 100 parts by weight of the compound represented by Formula 1.

8. The rechargeable lithium battery of claim 1, wherein the non-aqueous electrolyte further comprises an eluting additive for eluting transition elements from the positive electrode.

9. The rechargeable lithium battery of claim 8, wherein the eluting additive is an ester-based compound.

10. The rechargeable lithium battery of claim 9, wherein the eluting additive is at least one selected from the group consisting of phenyl acetate, benzyl benzoate, ethyl acetate, 1-naphthylacetate, 2-chromanone, and ethyl propinonate, and combinations thereof.

11. The rechargeable lithium battery of claim 9, wherein the eluting additive is included in an amount of 1 to 10 parts by weight based on 100 parts by weight of the non-aqueous electrolyte.

12. The rechargeable lithium battery of claim 1, wherein the lithium salt is selected from the group consisting of LiPF₆, LiBF₄, LiSbF₆, LiAsF₆, LiClO₄, LiCF₃SO₃, LiC₄F₉SO₃, LiN(CF₃SO₂)₂, LiN(C₂F₅SO₂)₂, LiAlO₄, LiAlCl₄, LiN(CₚF₂ₚ₊₁SO₂)(C_{q}F_{2q+1}SO₂) where p and q are natural numbers, LiSO₃CF₃, LiCl, LiI, lithium bisoxalate borate, and combinations thereof.

13. The rechargeable lithium battery of claim 1, wherein the non-aqueous organic solvent is selected from the group consisting of carbonate, ester, ether, ketone, and combinations thereof.

14. The rechargeable lithium battery of claim 1, wherein the non-aqueous organic solvent is a mixed solvent of a carbonate-based solvent and an aromatic hydrocarbon-based organic solvent represented by Formula 13: 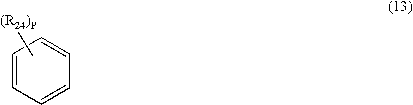
wherein R₂₄ is a halogen or an alkyl, and p is an integer ranging from 0 to 6.

15. The rechargeable lithium battery of claim 1, wherein the non-aqueous electrolyte further comprises another additive selected from the group consisting of a carbonate having a substituent selected from the group consisting of a halogen, a cyano (CN), and a nitro (NO₂); vinylene carbonate, and combinations thereof.

16. The rechargeable lithium battery of claim 1, wherein the non-aqueous electrolyte further comprises a carbonate represented by Formula 14: 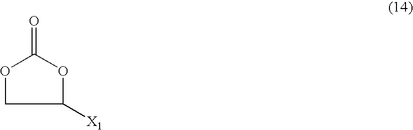
wherein X₁ is selected from the group consisting of a halogen, a cyano (CN), and a nitro (NO₂).

17. A rechargeable lithium battery comprising
a positive electrode comprising a positive active material capable of reversely intercalating/deintercalating lithium ions;
a negative electrode comprising a negative electrode active material comprising a compound represented by Formula 1:
LiₓM_{y}V_{z}O_{2+d} (1)
wherein 0.1≦x≦2.5, 0≦y≦0.5, 0.5≦z≦1.5, 0≦d≦0.5, and M is a metal selected from the group consisting of Al, Cr, Mo, Ti, W, Zr and combinations thereof; and
a non-aqueous electrolyte comprising a non-aqueous organic solvent, a lithium salt, and at least one additive compound, the additive compound being included in an amount of 0.1 to 10 wt % based on the total weight of the non-aqueous electrolyte, the additive selected from the group consisting of glutaronitrile, adiponitrile, and compounds represented by Formulae 7 to 12:

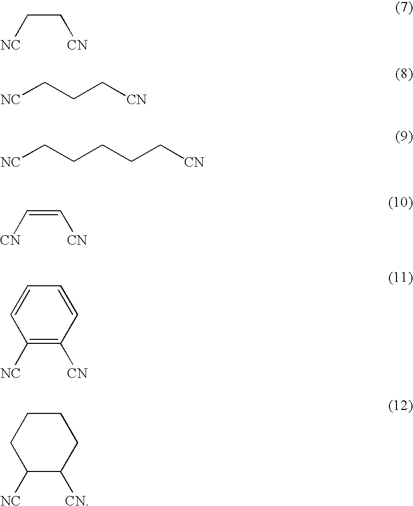

18. The rechargeable lithium battery of claim 17, wherein the negative active material further comprises graphite-based material selected from the group consisting of natural graphite, artificial graphite, and a combination thereof.

19. The rechargeable lithium battery of claim 17, wherein the non-aqueous electrolyte further comprises an eluting additive selected from the group consisting of phenyl acetate, benzyl benzoate, ethyl acetate, 1-naphthylacetate, 2-chromanone, and ethyl propinonate, and combinations thereof.

20. A rechargeable lithium battery comprising
a positive electrode comprising a positive active material capable of reversely intercalating/deintercalating lithium ions;
a negative electrode comprising a negative electrode active material comprising a compound represented by Formula 1:
LiₓM_{y}V_{z}O_{2+d} (1)
wherein 0.1≦x≦2.5, 0≦y≦0.5, 0.5≦z≦1.5, 0≦d≦0.5, and M is a metal selected from the group consisting of Al, Cr, Mo, Ti, W, Zr and combinations thereof; and
a non-aqueous electrolyte comprising:
a non-aqueous organic solvent comprising at least one of ester, ether, ketone, carbonate selected from the group consisting of dimethyl carbonate, diethyl carbonate, dipropyl carbonate, methylpropyl carbonate, ethylpropyl carbonate, methylethyl carbonate, ethylene carbonate, propylene carbonate, butylene carbonate, and combinations thereof;
a lithium salt selected from the group consisting of LiPF₆, LiBF₄, LiSbF₆, LiAsF₆, LiClO₄, LiCF₃SO₃, LiC₄F₉SO₃, LiN(CF₃SO₂)₂, LiN(C₂F₅SO₂)₂, LiAlO₄, LiAlCl₄, LiN(CₚF₂ₚ₊₁SO₂)(C_{q}F_{2q+1}SO₂) where p and q are natural numbers, LiSO₃CF₃, LiCl, LiI, lithium bisoxalate borate, and combinations thereof; and
at least one additive compound represented by one of Formulae 2 to 6: 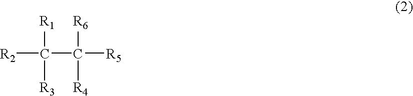
wherein R₁ to R₆ are the same or different, and are selected from the group consisting of hydrogen, a halogen, a substituted or unsubstituted alkyl, a substituted or unsubstituted aryl, and AₓR_{y}, where A is N, O, P or S, R is selected from the group consisting of CN, a substituted or unsubstituted alkyl, and carboxyl, x is 0 or 1, and y is determined according to the valance of A, with the proviso that at least two of R₁ to R₆ are CN; 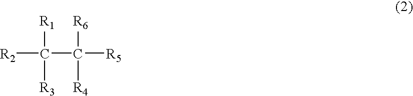
wherein R₁ to R₆ are the same or different, and are selected from the group consisting of hydrogen, a halogen, a substituted or unsubstituted alkyl, a substituted or unsubstituted aryl, and AₓR_{y}, where A is N, O, P or S, R is selected from the group consisting of CN, a substituted or unsubstituted alkyl, and carboxyl, x is 0 or 1, and y is determined according to the valance of A, with the proviso that at least two of R₁ to R₆ are CN; 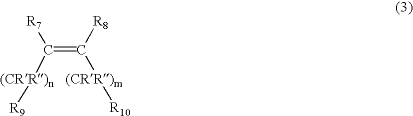
wherein R₇ to R₁₀ are the same or different, and are selected from the group consisting of hydrogen, a halogen, a substituted or unsubstituted alkyl, a substituted or unsubstituted aryl, and AₓR_{y}, where A is N, O, P or S, R is selected from the group consisting of CN, a substituted or unsubstituted alkyl, and carboxyl, x is 0 or 1, and y is determined according to the valance of A, R′ and R″ are independently hydrogen or a lower alkyl, and n and m are an integer ranging from 0 to 10, with the proviso that at least two of R₇ to R₁₀ are CN; 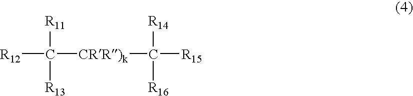
wherein R₁₁ to R₁₆ are the same or different, and are selected from the group consisting of hydrogen, a halogen, a substituted or unsubstituted alkyl, a substituted or unsubstituted aryl, and AₓR_{y}, where A is N, O, P or S, R is selected from the group consisting of CN, a substituted or unsubstituted alkyl, and carboxyl, x is 0 or 1, y is determined according to the valance of A, and k ranges from 0 to 10, with the proviso that at least two of R₁₁ to R₁₄ are CN;
CN—R₁₈—CN (5)
wherein R₁₈ is an aromatic cycle, an aromatic heterocycle, or an aliphatic cycle, with the proviso that two cyano groups are connected to adjacent carbons of the cycle; and 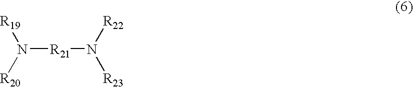
wherein R₁₉, R₂₁, R₂₂, and R₂₃ are the same or different, and are selected from the group consisting of hydrogen, a halogen, a substituted or unsubstituted alkyl, a substituted or unsubstituted aryl and AₓR_{y}) where A is N, O, P or S, R is selected from the group consisting of CN, a substituted or unsubstituted alkyl, and carboxyl, x is 0 or 1, and y is determined according to the valance of A, R₂₁ is selected from the group consisting of an alkylene, a cycloalkylene, and an arylene, with the proviso that at least two of R₁₉, R₂₁, R₂₂, and R₂₃ are CN.
